(19) United States
(12) Patent Application Publication
(10) Pub. No.: US 2009/0319985 A1
(43) Pub. Date: Dec. 24, 2009

(54) METHOD, SYSTEM AND APPARATUS FOR ACQUIRING INTERFACE

(75) Inventor: Yi Sun, Chengdu (CN)

Correspondence Address: Huawei Technologies Co., Ltd.;c/o Darby & Darby P.C., P.O. Box 770, Church Street Station, New York, NY, 10008-0770, US

(73) Assignee: CHENGDU HUAWEI SYMANTEC TECHNOLOGIES CO., LTD., Chengdu (CN)

(21) Appl. No.: 12/475,678

(22) Filed: Jun. 1, 2009

(30) Foreign Application Priority Data
Jun. 23, 2008 (CN) 200810028977.9

(51) Int. Cl. G06F 9/44

(52) U.S. Cl. 717/106

(57) ABSTRACT

A method, system and apparatus for acquiring an interface are provided. The method includes: acquiring, by an interface requester, an interface identification and an interface generation parameter in response to a request from a client, transmitting the interface identification and the interface generation parameter to an interface arranger, the interface identification being used to identify an interface generator that may generate an interface; generating, by an interface arranger, an interface instance at the interface generator based on the received interface identification and interface generation parameter; and delivering, by the interface arranger, the interface instance to the client through a communication mechanism between the interface requester and the interface arranger. According to the disclosure, the software extensibility may be improved, the software development cycle may be shortened, and the software maintainability may be enhanced.

### CROSS-REFERENCE TO RELATED APPLICATIONS

This application claims priority to Chinese Patent Application No. 200810028977.9, filed on Jul. 23, 2008, which is hereby incorporated by reference in its entirety.

### FIELD

The disclosure relates to the field of interface technologies, and more particularly, to a method, system and apparatus for acquiring an interface.

### BACKGROUND

At present, the size of a software system is becoming larger and larger. Typically, a large system is made up of subsystems that have relatively independent functions and operations. The development of the interfaces between these subsystems is always an important issue that restricts the software design.

The present interface development mainly involves two different solutions, each of which is described below.

The first solution is shown in FIG. 1, in which a block diagram of the first solution is illustrated. As depicted, a client module 1, a client module 2, a client module 3, a server module 1, a server module 2, and a server module 3 may represent modules within the client subsystem and the server subsystem, respectively.

In this solution, an interface (Facade in the figure) is established between the client subsystem and the server subsystem. All communications between each client module and each server module are performed via the interface. The interface includes functions provided from each sub-module in the server subsystem to each module in the client subsystem.

The design of such a large interface facilitates reduction in the coupling degree between the subsystems. Meanwhile, due to a single entry point, all interface functions required by the client may be obtained in the interface after each module in the client obtains the interface.

During implementing the present invention, the inventors find that the first solution has the following disadvantages at least. The interface becomes very large because the interface includes all functions. The existing interface has to be modified when a new function is added, which leads to poor maintainability.

The second solution is shown in FIG. 2. In this solution, there is an interface between each client module and each corresponding server module. The client module first communicates with a controlling module (Interface Creator) at the server, and acquires a corresponding interface for the server module from the controlling module. Upon accepting the request, the controlling module may generate a corresponding interface, and return the information (for example, reference information) to the client module so that the client module may use the interface. Then, the controlling module may generate a corresponding interface based on the information so that the client module may perform communication with the server module.

During implementing the present invention, the inventors find that the second solution has at least the following disadvantages. In the second solution, the client module has to interact with the controlling module for twice or even more times before obtaining the corresponding interface at the server. Meanwhile, if a new module is to be added, the Interface Creator has to be modified to acquire a new interface.

### SUMMARY

In view of the above, various embodiments of the disclosure are directed to providing a method, system and apparatus for acquiring an interface

An embodiment of the disclosure provides a method for acquiring an interface. The method includes: acquiring, by an interface requester, an interface identification and an interface generation parameter in response to a request from a client, and transmitting the interface identification and the interface generation parameter to an interface arranger, the interface identification is used to identify an interface generator that may generate a corresponding interface; generating, by an interface arranger, an interface instance at the interface generator based on the received interface identification and interface generation parameter; and delivering, by the interface arranger, the interface instance to the client through a communication mechanism between the interface requester and the interface arranger.

Another embodiment of the disclosure provides an apparatus for acquiring an interface. The apparatus includes: an interface requester, an interface arranger, and an interface generator. The interface requester is configured to acquire an interface identification and an interface generation parameter in response to a request from a client, and transmit the interface identification and the interface generation parameter to the interface arranger, the interface identification being used to identify the interface generator that may generate a corresponding interface. The interface arranger is configured to generate a corresponding interface instance at the interface generator based on the received interface identification and interface generation parameter.

Still another embodiment of the disclosure provides a system for acquiring an interface. The system includes a first subsystem and a second subsystem. The first subsystem includes an interface requester, the interface requester configured to acquire an interface identification and an interface generation parameter in response to a request from a corresponding unit of the first subsystem, and transmit the interface identification and the interface generation parameter to an interface arranger, the interface identification being used to identify an interface generator that may generate a corresponding interface. The second subsystem includes the interface arranger and the interface generator, the interface arranger configured to generate an interface instance at the interface generator based on the received interface identification and interface generation parameter.

As indicated above, and explained below, exemplary embodiments of the disclosure may solve problems identified by related arts and provides additional advantages.

### BRIEF DESCRIPTION OF THE DRAWINGS

To clearly illustrate the solutions in embodiments of the disclosure or the related art, a brief description is made below to the accompanying drawings used in description of the embodiments or the prior art. Apparently, the accompanying drawings are referred in connection with only some embodiments of the disclosure. For those skilled in the art, other drawings may be available from these accompanying drawings without efforts of undue experimentation.

FIG. 1 is a block diagram showing the modules in the first related art;

FIG. 2 is a block diagram showing the modules in the second related art;

FIG. 3 is a block diagram showing a system for acquiring an interface according to an embodiment of the disclosure;

FIG. 4 is a block diagram showing an interface generator according to an embodiment of the disclosure;

FIG. 5 is a block diagram showing a system for acquiring an interface according to another embodiment of the disclosure;

FIG. 6 is a flow chart showing a method for acquiring an interface according to an embodiment of the disclosure;

FIG. 7 is a class diagram showing a program implementing the method for acquiring an interface according to the disclosure; and

FIG. 8 is a flow chart showing a method for acquiring an interface according to another embodiment of the disclosure.

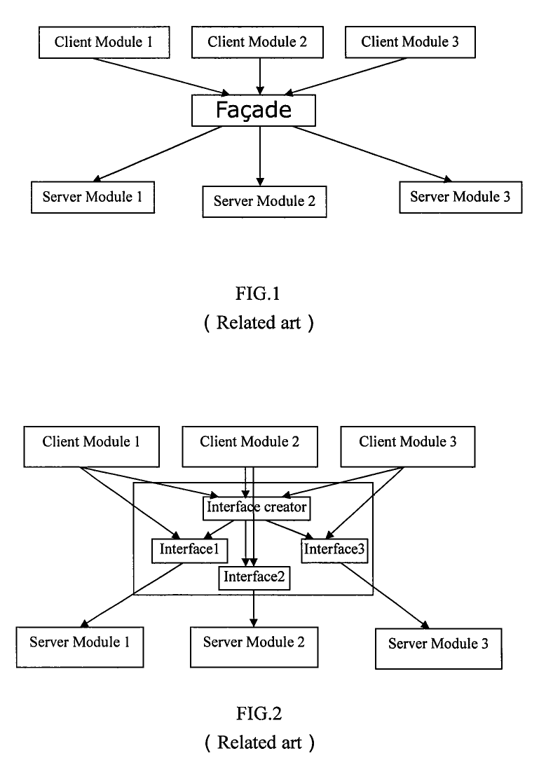

### DETAILED DESCRIPTION

A clear and full description is made below to the solutions according to embodiments of the disclosure, with reference to the accompanying drawings. Apparently, the illustrated embodiments only represent some but not all embodiments of the disclosure. All other embodiments obtained by those skilled in the art based on the embodiments of the disclosure without efforts of undue experimentation fall within the scope of the disclosure.

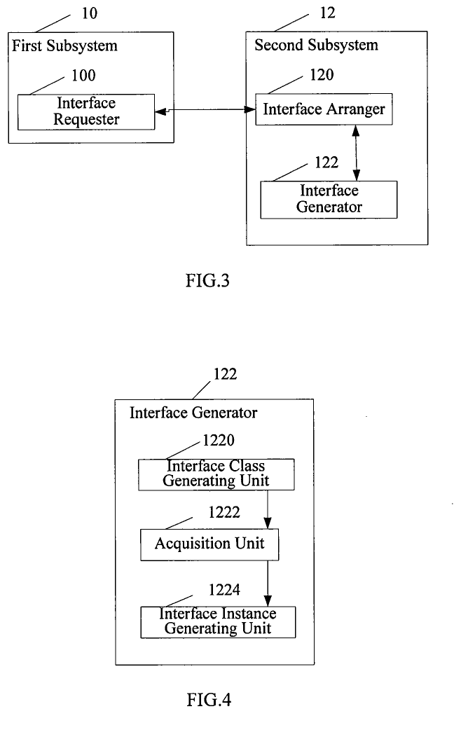

Referring to FIG. 3, a system for acquiring an interface is shown according to an embodiment of the disclosure. The system may include a first subsystem 10 and a second subsystem 12.

The first subsystem 10 includes an interface requester 100. The second subsystem 12 includes an interface arranger 120 and an interface generator 122. The interface requester 100 is configured to acquire an interface identification and an interface generation parameter in response to a request from a corresponding unit of the first subsystem 10, and transmit the interface identification and the interface generation parameter to the interface arranger 120 of the second subsystem 12. The interface identification is used to identify the interface generator 122 that may generate a corresponding interface.

The interface arranger 120 is configured to generate an interface instance at the interface generator 122 based on the received interface identification and interface generation parameter.

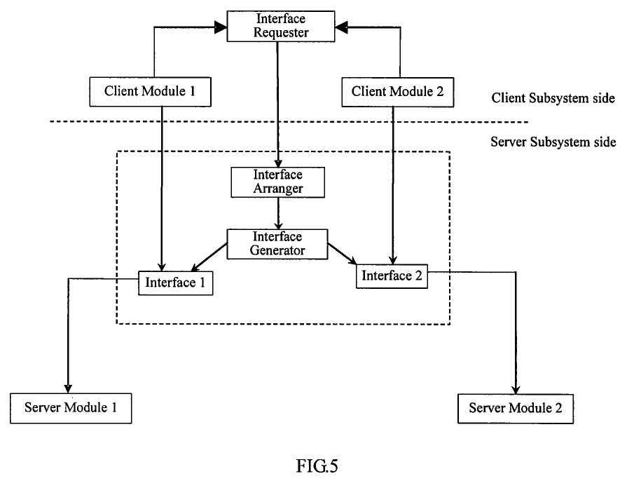

Further, as shown in FIG. 4, the interface generator 122 includes an interface class generating unit 1220, an acquisition unit 1222, and an interface instance generating unit 1224. The interface class generating unit 1220 is configured to generate an interface class based on the interface identification sent from the interface arranger 120. The acquisition unit 1222 is configured to acquire a construct function based on the identification of the interface class and the interface generation parameter sent from the interface arranger 120. The interface instance generating unit 1224 is configured to generate the corresponding interface instance based on the interface class and the construct function sent from the interface arranger 120.

Furthermore, the interface instance is delivered from the second subsystem 12 to the first subsystem 10 through a communication mechanism between the interface requester 100 and the interface arranger 120.

From the above description, there is no need for each module in a subsystem, for example, a module in the client subsystem, to know how to acquire a corresponding interface in another subsystem, for example, a module in the server subsystem. Instead, it is processed independently by an interface requester in the subsystem. The interface requester communicates with the interface arranger in another subsystem. The interface arranger may be associated with a corresponding module in the server based on relevant information, such as, the interface identification or the like, so that the interface generator creates an interface instance and returns the instance to the module in the client so as to be called.

In this way, a module in the client may obtain a required interface with a module in the server automatically. If a new function is added to the system, and hence new modules are added to the client and server subsystems, an interface between the corresponding modules in the client subsystem and the server subsystem may be obtained automatically with the above mechanism. The example is shown in FIG. 5, in which the client subsystem includes a client module 1 and a client module 2, and the server subsystem includes a server module 1 and a server module 2. Through the above interactions, interface 1 and interface 2 are generated, so as to be called by the corresponding modules.

Accordingly, an embodiment of the disclosure also provides an apparatus for acquiring an interface. The apparatus includes an interface requester, an interface arranger, and an interface generator similar to those illustrated above.

The interface requester is configured to acquire an interface identification and an interface generation parameter in response to a request from a client, and to transmit the interface identification and the interface generation parameter to the interface arranger, the interface identification being used to identify the interface generator that may generate a corresponding interface.

The interface arranger is configured to generate the corresponding interface instance and interface reference at the interface generator based on the received interface identification and interface generation parameter.

The interface generator includes an interface class generating unit, an acquisition unit, and an interface instance generating unit. The interface class generating unit is configured to generate an interface class based on the interface identification sent from the interface arranger. The acquisition unit is configured to acquire a construct function based on the identification of the interface class and the interface generation parameter sent from the interface arranger. The interface instance generating unit is configured to generate the interface instance and the interface reference based on the interface class and the construct function sent from the interface arranger.

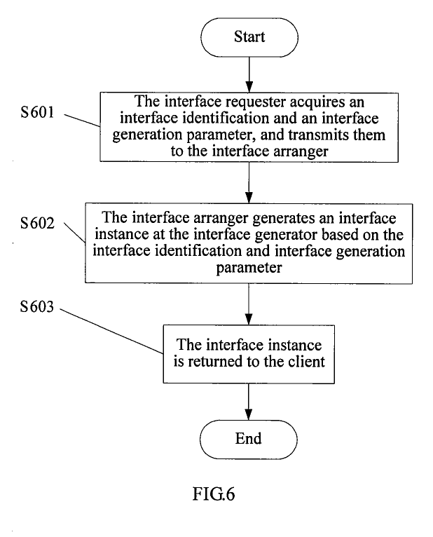

As shown in FIG. 6, a flow chart is shown for illustrating a method for acquiring an interface according to an embodiment of the disclosure.

In block 601, an interface requester may acquire an interface identification and an interface generation parameter in response to a request from a client, and transmit the interface identification and the interface generation parameter to an interface arranger, the interface identification being used to identify the interface generator that may generate a corresponding interface. The interface identification may be acquired from a configuration file.

In block 602, the interface arranger may generate a corresponding interface instance at the interface generator based on the received interface identification and interface generation parameter.

Specifically, the step may include the following sub-steps.

Based on the interface identification, the interface arranger instructs the corresponding interface class generator to generate a corresponding interface class. For example, the interface arranger may acquire the interface class through the interface identification by using the Reflect mechanism in Java (the Java program design language and the Java platform developed by Sun Microsystems Inc. in May 1995 may be collectively referred to as Java).

The interface arranger acquires a corresponding construct function based on the identification of the interface class and the interface generation parameter.

The interface arranger instructs the corresponding interface instance generator to generate the corresponding interface instance based on the interface class and the construct function.

In block 603, the interface instance is delivered to the client with the communication mechanism between the interface requester and the interface arranger.

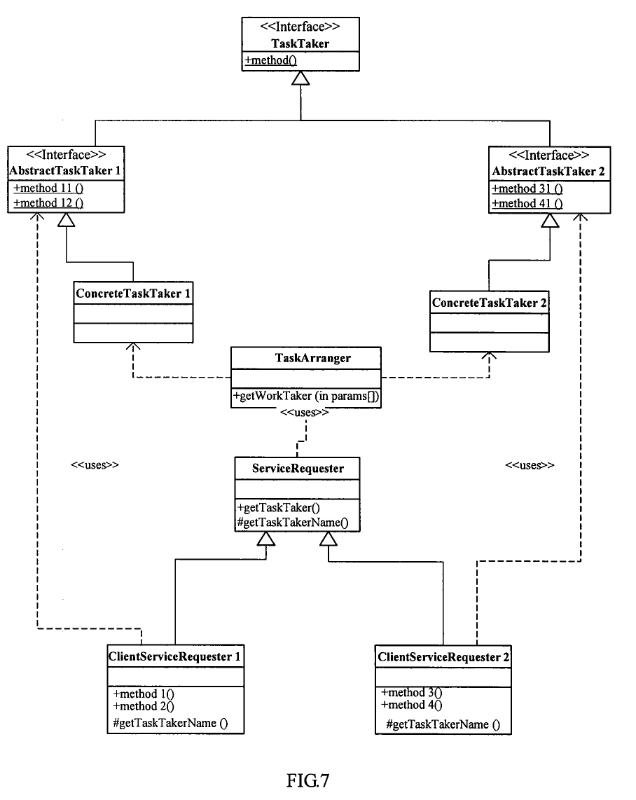

The details of an interface generation program implemented with the above method are described below. Referring to FIG. 7, a class diagram is shown for a program implementing the above method for acquiring an interface. As depicted, ClientServiceRequester1 and ClientServiceRequester2 are classes at the client, corresponding to the client module 1 and the client module 2 in FIG. 5. In ClientServiceRequester1 and ClientServiceRequester2, sub-functions are further defined: method1, method2 and getTaskTakerName. Here, method1 and method2 correspond to specific tasks of the function interface, and getTaskTakerName is used to get the name of a TaskTaker for the corresponding server segment. As shown in FIG. 7, method1 and method 2 are the functions (referred to as function in the process oriented languages such as C) defined by the client module or class.

ServerRequester is a specific class implemented for the interface requester, including sub-functions getTaskTaker and getTaskTakerName. TaskArranger is a specific class implemented for the interface arranger, including a sub-function getWorkTaker. TaskTaker is a class implemented for the interface between the client subsystem and the server subsystem. However, TaskTaker only defines the common characteristics of the interface, or even may be an empty interface, just for the purpose of taking advantage of the OO (Object-Oriented) polymorphism.

ServiceRequester has no need to know the specific interface. ServiceRequester interacts with TaskArranger in the server subsystem, and acquires the implementer (i.e., the interface generator) of the subclass (for example, named as xxTaskTaker) for the TaskTaker of the corresponding module in the server subsystem, so as to perform a task.

The interface generator may generate classes AbstractTaskTaker (AbstractTaskTaker1 including sub-functions method11 and method12, AbstractTaskTaker2 including sub-functions method31 and method41) and ConcreteTaskTasker. AbstractTaskTaker is the interface class between the corresponding modules in the client and the server, and may be implemented by ConcreteTaskTasker so as to be called by ServiceRequester. It defines a function for an interface provided from a module in the server to a corresponding module in the client. ConcreteTaskTasker is an implementation of the interface AbstractTaskTaker (corresponding to the interfaces 1 and 2 in FIG. 5) between the corresponding modules in the server and the client. It accepts a request from the client, and provides services as needed.

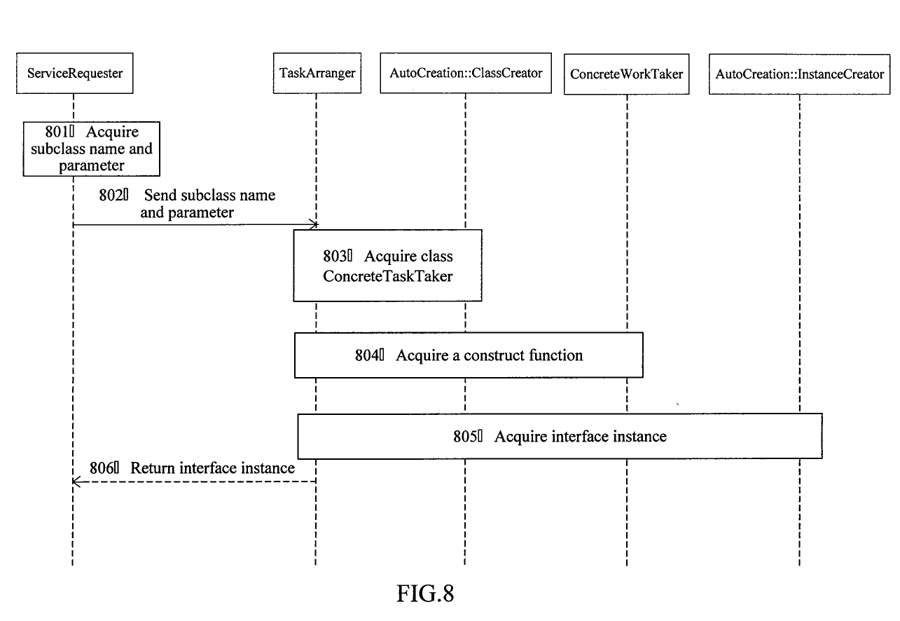

In connection with the definitions of the classes in the above program, the process for acquiring an interface is explained below in detail. As shown in FIG. 8, the following steps are included.

In block 801, ServiceRequester at the client responds to a request (such as, a request to communicate with the server) from another corresponding module (such as ClientServiceRequester1) at the client, and acquires the subclass name of TaskTaker at the server corresponding to ConcreteServiceRequester in a certain manner, for example xxTaskTaker (corresponding to the interface identification in FIG. 6), as well as the corresponding interface generation parameter.

The name of the subclass TaskTaker may be obtained by putting the prefix of ServiceReqester of the client to the front of TaskTaker. Alternatively, the subclass name of TaskTaker may be acquired from a configuration file.

In block 802, ServiceRequester delivers the subclass name of the TaskTaker and the interface generation parameter (for example, parameter categorization, parameter value, or the like) to TaskArranger at the server in a certain communication manner.

In block 803, upon obtaining the subclass name of a particular TaskTaker, TaskArranger may acquire a corresponding class (for example, ConcreteTaskTaker1 and ConcreteTaskTaker1) for processing the request from the client by using the Reflect mechanism in Java or the like. The class may be generated by the interface class generator (for example, the AutoCreation::ClassCreator function in the figure).

In block 804, TaskArranger acquires a construct function (constructor) via the delivered parameter and the acquired class name of ConcreteTaskTaker. The construct function may be generated by ConcreteWorkTaker.

In block 805, TaskArranger acquires an instance of ConcreteTaskTaker with the value of the constructor obtained from the ServerRequester (that is, a part of the interface parameter) and the above constructor. The instance may be generated by the interface instance generator (for example, AutoCreation::InstanceCreator in the figure).

In block 806, the instance (ConcreteTaskTaker), reference or remote reference of TaskTaker obtained via the above procedure may be delivered to ServiceRequester at the client through the communication mechanism between TaskArranger and ServiceRequester, so as to be used by the specific ServiceRequester in each module.

It can be seen from the above description that in the method, apparatus, and system as provided according to embodiments of the disclosure, there is no need for each client module to know how to acquire a corresponding interface for a module in the server subsystem. Rather, the server subsystem may generate an interface for a particular module automatically only based on the interface identification and the interface generation parameter.

Thus, the software extensibility may be improved greatly. When a new module is to be added to the software system/platform, the newly added function interface may be processed without modifying the interface processing mechanism between the subsystems. This is also the key for the platform extensibility.

Meanwhile, the software development cycle may be shortened. Because there is no need to modify the original code, the interface processing has an adaptive mechanism such that the software function extensibility is improved greatly and the development cycle is shortened greatly.

Additionally, the software maintainability may be enhanced. No code modification is needed for addition or removal of a software module. Rather, it may be done by adding or removing a corresponding software package, and adding, removing, or modifying a corresponding configuration file.

Those skilled in the art will appreciate that a part or all of a process in the above illustrated method may be implemented in hardware executing a computer program. The program may be stored in a computer readable storage media. When the program is executed, the processes in the above illustrated embodiments may be included. The storage media may be a magnetic disc, optical disc, Read-Only Memory (ROM), Random Access Memory (RAM), etc.

The disclosure has been described above with reference to specific embodiments, which are not used to limit the scope of the disclosure. Various equivalent changes made from the claims of the disclosure fall within the scope of the disclosure.

What is claimed is:

1. A method for acquiring an interface, comprising:
acquiring, by an interface requester, an interface identification and an interface generation parameter in response to a request from a client, and transmitting the interface identification and the interface generation parameter to an interface arranger, wherein the interface identification is used to identify an interface generator that may generate a corresponding interface;
generating, by an interface arranger, an interface instance at the interface generator based on the received interface identification and interface generation parameter; and
delivering, by the interface arranger, the interface instance to the client through a communication mechanism between the interface requester and the interface arranger.

2. The method according to claim 1, wherein the interface identification is stored in a configuration file.

3. The method according to claim 1, wherein the act of generating the interface instance at the interface generator based on the received interface identification and interface generation parameter comprises:
instructing a corresponding interface class generator to generate and return a corresponding interface class based on the interface identification;
acquiring a corresponding construct function based on the identification of the interface class and the interface generation parameter; and
instructing a corresponding interface instance generator to generate and return the interface instance based on the construct function and the interface generation parameter.

4. The method according to claim 3, wherein the act of instructing the corresponding interface class generator to generate and return the corresponding interface class based on the interface identification, comprises:
acquiring the interface class through the interface identification using the Reflect mechanism in Java.

5. An apparatus for acquiring an interface, comprising an interface requester, an interface arranger, and an interface generator, wherein:
the interface requester is configured to:
acquire an interface identification and an interface generation parameter in response to a request from a client, and
transmit the interface identification and the interface generation parameter to the interface arranger, wherein the interface identification is used to identify the interface generator that may generate a corresponding interface; and
the interface arranger is configured to generate a corresponding interface instance at the interface generator based on the received interface identification and interface generation parameter.

6. The apparatus according to claim 5, wherein the interface generator comprises:
an interface class generating unit, configured to generate a corresponding interface class based on the interface identification sent from the interface arranger;
an acquisition unit, configured to acquire a corresponding construct function based on the identification of the interface class and the interface generation parameter sent from the interface arranger; and
an interface instance generating unit, configured to generate the interface instance based on the interface class and the construct function sent from the interface arranger.

7. A system for acquiring an interface, comprising: a first subsystem and a second subsystem, wherein:
the first subsystem comprises an interface requester, the interface requester being configured to:
acquire an interface identification and an interface generation parameter in response to a request from a corresponding unit of the first subsystem, and
transmit the interface identification and the interface generation parameter to an interface arranger, wherein the interface identification is used to identify an interface generator that may generate a corresponding interface; and
the second subsystem comprises the interface arranger and the interface generator, the interface arranger being configured to generate a corresponding interface instance at the interface generator based on the received interface identification and interface generation parameter; and
wherein the interface instance is delivered from the second subsystem to the first subsystem through a communication mechanism between the interface requester and the interface arranger.

8. The system according to claim 7, wherein the interface generator comprises:
an interface class generating unit, configured to generate a corresponding interface class based on the interface identification sent from the interface arranger;
an acquisition unit, configured to acquire a corresponding construct function based on the identification of the interface class and the interface generation parameter sent from the interface arranger; and
an interface instance generating unit, configured to generate the interface instance based on the interface class and the construct function sent from the interface arranger.
